(19) United States
(12) Patent Application Publication
(10) Pub. No.: US 2021/0117908 A1
(43) Pub. Date: Apr. 22, 2021

(54) Graph views and models for representing networks and associated inventory

(71) Applicant: Ciena Corporation, Hanover, MD (US)

(72) Inventors: Richard Coles, Birmingham (GB); Owain Cole, Malmesbury (GB)

(21) Appl. No.: 16/654,358

(22) Filed: Oct. 16, 2019

(51) Int. Cl. G06Q 10/08; H04L 12/24; G06F 16/28; G06Q 30/02; G06F 16/903

(52) U.S. Cl. CPC G06Q 10/087; H04L 41/12; G06F 16/90348; G06Q 30/02; G06F 16/28

(57) ABSTRACT

Systems and methods provide graph views and models for representing networks and associated inventory. A management system includes models of service and network inventory, their relationships, and state. To support the processes effectively, the inventory must provide capabilities to change the state of the inventory to reflect changes within the network or planning processes for the intention of the network. The present disclosure includes a technique for providing multiple views of (inventory) data via the relationships in a graph database. The present disclosure further includes a metadata specification that is an approach for defining compatibility between types of entities, separate from the composition representing their constituent parts. Finally, the present disclosure includes behavior modeling that is a mechanism to attach behaviors to entities in the model, and re-use existing behaviors for new entities in the future when added to the model.

### FIELD OF THE DISCLOSURE

The present disclosure generally relates to networking equipment. More particularly, the present disclosure relates to systems and methods for graph views and models for representing networks and associated inventory.

### BACKGROUND OF THE DISCLOSURE

Networks are formed through various network elements, devices, etc. which are network equipment including physical hardware, namely chassis, shelves, modules, line cards, blades, etc. Further, the network equipment is managed by Network Management Systems (NMS), Operation Support Systems (OSSs), Element Management Systems (EMS), etc. which provide an interface for Operations, Administration, Maintenance, and Provisioning (OAM&P) functions, generally referred to herein as network management. One aspect of network management includes inventory management, which forms a key part of network management. Inventory management includes models of service and network inventory, their relationships, and state. To support the processes effectively, the inventory must provide capabilities to change the state of the inventory to reflect changes within the network or planning processes for the intention of the network.

### BRIEF SUMMARY OF THE DISCLOSURE

The present disclosure relates to systems and methods for graph views and models for representing networks and associated inventory. A management system includes models of service and network inventory, their relationships, and state. To support the processes effectively, the inventory must provide capabilities to change the state of the inventory to reflect changes within the network or planning processes for the intention of the network. To that end, the present disclosure includes a technique for providing multiple views of (inventory) data via the relationships in a graph database. The present disclosure further includes a metadata specification that is an approach for defining compatibility between types of entities, separate from the composition representing their constituent parts. Finally, the present disclosure includes behavior modeling that is a mechanism to attach behaviors to entities in the model, and re-use existing behaviors for new entities in the future when added to the model. The present disclosure includes a dynamic inventory graph model that is managed by a management system.

In an embodiment, a method and a non-transitory computer-readable medium can include instructions that, when executed, cause a processor to perform steps of obtaining data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network; recording the inventory and the associated relationships in a graph database that includes nodes that are points in a graph and with directed vertices between the points based on the associated relationships, wherein each node includes one or more properties and one or more labels, and wherein each of the directed vertices includes a type; and querying the graph database for any of capacity management, inventory management, network planning, and network maintenance.

The graph database can include a plurality of layers of granularity including metadata that is used to specify behavior and rules between the nodes and the relationships. The graph database can include a plurality of layers of granularity including a Hypermodel that defines the nodes and the relationships including equipment, addresses, and interfaces and a Metamodel that refines the Hypermodel to define inventory objects including devices, cards, locations, and ports. The graph database can include a plurality of layers of granularity including an Archetype and Archetype Instance, wherein the Archetype defines a type of inventory and compatibilities, and the Archetype Instance defines composition of the inventory.

The method and the instructions that, when executed, can further cause the processor to perform steps of defining a perspective for each node where the perspective is one of planned and operational, wherein the perspective is utilized to determine visibility during the querying. The perspective for the planned nodes can include a date when it transitions to operational. The method and the instructions that, when executed, can further cause the processor to perform steps of presenting a User Interface with a graphical representation based on the querying. The nodes can include any of a location, a rack, a shelf, a slot position on the shelf, a card in the slot position, a pluggable in the card, and one or more physical ports in the card or the pluggable.

In another embodiment, an apparatus includes a processor; and memory storing instructions that, when executed, cause the processor to obtain data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network, record the inventory and the associated relationships in a graph database that includes nodes that are points in a graph and with directed vertices between the points based on the associated relationships, wherein each node includes one or more properties and one or more labels, and wherein each of the directed vertices includes a type, and query the graph database for any of capacity management, inventory management, network planning, and network maintenance.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network with five interconnected sites;

FIG. 2 is a block diagram of a server which may be used to implement the management system, the SDN controller, etc.;

FIG. 3 is a diagram that logically illustrates entries in a graph database;

FIG. 4 is an example of instance data in the graph database;

FIG. 5 is a diagram of a dynamic inventory graph;

FIG. 6 is a graph of a Metamodel excerpt for equipment in the graph format;

FIG. 7 is a graph of a Metamodel excerpt for logical connectivity;

FIG. 8 is a graph of a Metamodel excerpt for aspects of customer ordering, servicing, and planning;

FIG. 9 is a graph of Archetypes and Archetype Instances;

FIG. 10 is a graph of an example physical connection;

FIG. 11 is a graph illustrating an example of Perspectives and Activities;

FIG. 12 is a graph illustrating an example of Dependency Management in a graph;

FIG. 13 is a graph illustrating a transition from planning to operational;

FIG. 14 is a graph illustrating example Metadata nodes; and

FIG. 15 is a flowchart of a process for inventory management via a graph database.

### DETAILED DESCRIPTION OF THE DISCLOSURE

Again, the present disclosure relates to systems and methods for graph views and models for representing networks and associated inventory. A management system includes models of service and network inventory, their relationships, and state. To support the processes effectively, the inventory must provide capabilities to change the state of the inventory to reflect changes within the network or planning processes for the intention of the network. To that end, the present disclosure includes a technique for providing multiple views of (inventory) data via the relationships in a graph database. The present disclosure further includes a metadata specification that is an approach for defining compatibility between types of entities, separate from the composition representing their constituent parts. Finally, the present disclosure includes behavior modeling that is a mechanism to attach behaviors to entities in the model, and re-use existing behaviors for new entities in the future when added to the model. The present disclosure includes a dynamic inventory graph model that is managed by a management system.

### Multi-Layer Network

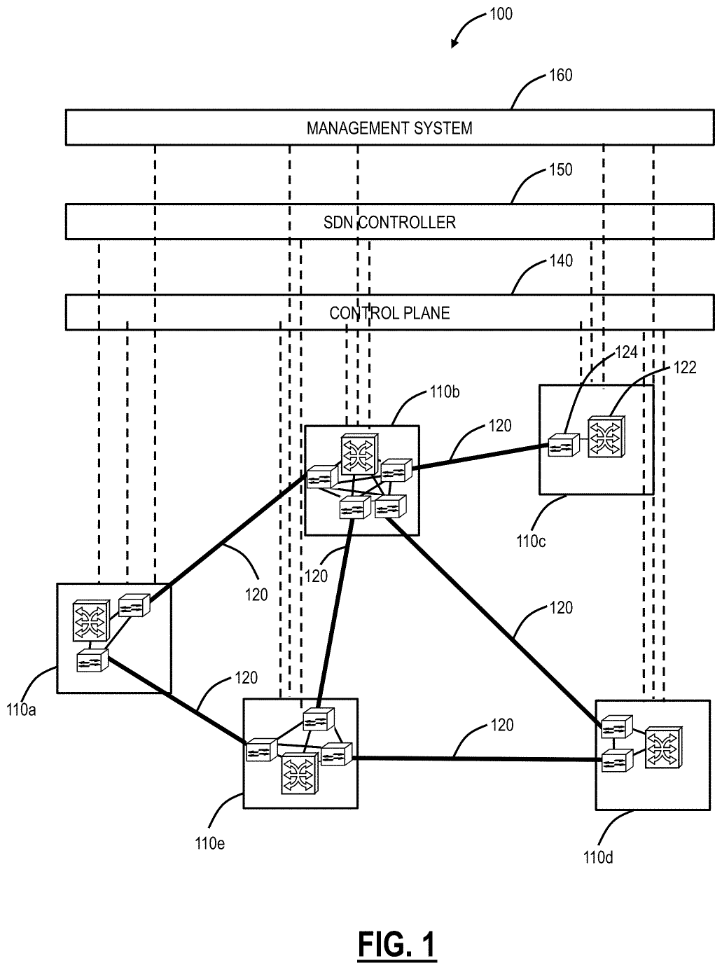

FIG. 1 is a network diagram of a network 100 with five interconnected sites 110a, 110b, 110c, 110d, 110e. The sites 110 are interconnected by a plurality of links 120. Each of the sites 110 can include a switch 122 and one or more WDM network elements 124. The switch 122 is configured to provide services at Layers 1 (e.g., Time Division Multiplexing (TDM), Optical Transport Network (OTN)) and/or Layer 2 (e.g., Ethernet, MPLS) and/or Layer 3 (e.g., IP) where the switch would normally be called a router. For illustration purposes, the network 100 is a multi-layer network with optical, TDM, packet, etc. Those skilled in the art will recognize any type of network at any layer or layers is contemplated herein with the network 100 presented as an example.

The WDM network elements 124 provide the photonic layer (e.g., Layer 0) and various functionality associated therewith (e.g., multiplexing, amplification, optical routing, wavelength conversion/regeneration, local add/drop, etc.) including photonic control. Of note, while shown separately, those skilled in the art will recognize that the switch 122 and the WDM network elements 124 may be realized in the same network element. The photonic layer and the photonic control operating thereon can also include intermediate amplifiers and/or regenerators on the links 120, which are omitted for illustration purposes. The network 100 is illustrated, for example, as an interconnected mesh network, and those skilled in the art will recognize the network 100 can include other architectures, with additional sites 110 or with fewer nodes sites, with additional network elements and hardware, etc.

The sites 110 communicate with one another optically over the links 120. The sites 110 can be network elements, which include a plurality of ingress and egress ports forming the links 120. Further, the nodes 110 can include various degrees, i.e., the site 110c is a one-degree node, the sites 110a, 110d are two-degree nodes, the site 110e is a three-degree node, and the site 110b is a four-degree node. The number of degrees is indicative of the number of adjacent nodes at each particular node. The network 100 includes a control plane 140 operating on and/or between the switches 122 at the sites 110a, 110b, 110c, 110d, 110e. The control plane 140 includes software, processes, algorithms, etc. that control configurable features of the network 100, such as automating discovery of the switches 122, capacity of the links 120, port availability on the switches 122, connectivity between ports; dissemination of topology and bandwidth information between the switches 122; calculation and creation of paths for connections; network-level protection and restoration; and the like. In an embodiment, the control plane 140 can utilize Automatically Switched Optical Network (ASON), Generalized Multiprotocol Label Switching (GMPLS), or the like. Those of ordinary skill in the art will recognize the optical network 100, and the control plane 140 can utilize any type of control plane for controlling the switches 122 and establishing connections.

The optical network 100 can also include a Software-Defined Networking (SDN) controller 150. SDN allows management of network services through abstraction of lower-level functionality. This is done by decoupling the system that makes decisions about where traffic is sent (SDN control through the SDN controller 150) from the underlying systems that forward traffic to the selected destination (i.e., the physical equipment in the network 100). Work on SDN calls for the ability to centrally program provisioning of forwarding on the optical network 100 in order for more flexible and precise control over network resources to support new services. The SDN controller 150 is a processing device that has a global view of the optical network 100. Additionally, the SDN controller 150 can include or connect to SDN applications which can utilize the data from the SDN controller 150 for various purposes.

There are various techniques for data communications between the switches 122, the WDM network elements 124, the control plane 140, the SDN controller 150, and a management system 160 for OAM&P purposes. These various techniques can include one or more of Optical Service Channels (OSCs), overhead communication channels, in-band communication channels, and out-of-band communication channels. OSCs are dedicated wavelengths between WDM network elements 124. The overhead communication channels can be based on SONET, SDH, or OTN overhead, namely the Data Communication Channel (DCC) or General Communication Channel (GCC). The in-band communications channels and the out-of-band communication channels can use various protocols for OAM&P communications in the network 100.

The present disclosure focuses on inventory management of devices and services in a network, via a management system 160. Again, the network 100 is presented for illustration purposes as one possible network for use with the inventory management systems and methods described herein. Various types of networks are contemplated, including single-layer networks, single protocol networks, etc. For example, one network implementation may only include the switches 122 providing packet connectivity, with the TDM and optical layers omitted (of course, these exist as an underlay network, but can be managed separately). Further, those skilled in the art will recognize the control plane 140 and/or the SDN controller 150 may be omitted in some applications.

### Server

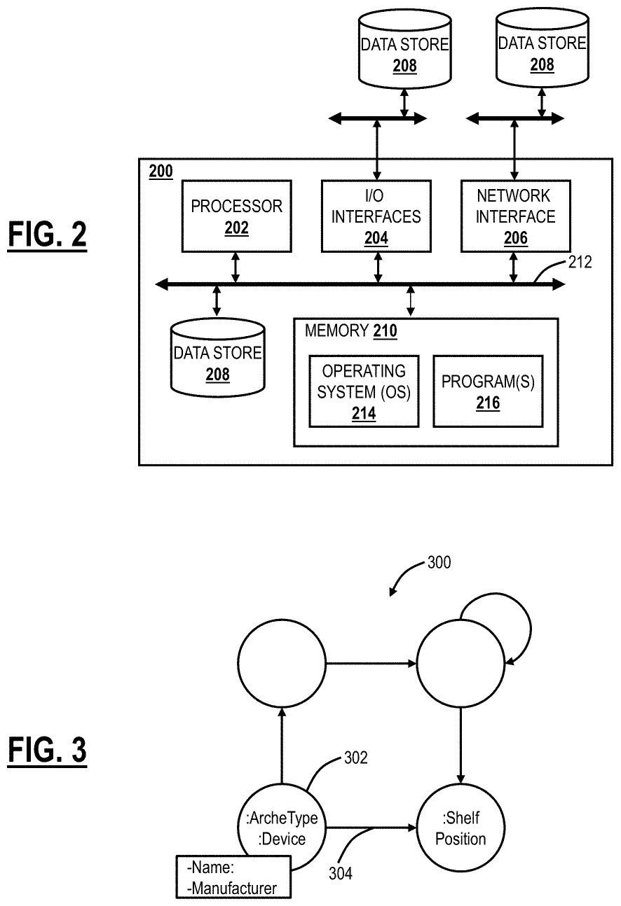

FIG. 2 is a block diagram of a server 200, which may be used to implement the management system 150, the SDN controller 160, etc. In the systems and methods described herein, the server 200 can be used to present a User Interface (UI) or Graphical UI (GUI) to an operator for accomplishing the various processes described herein. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and practical embodiments may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. The user input may be provided via, for example, a keyboard, touchpad, and/or a mouse. The system output may be provided via a display device and a printer (not shown). I/O interfaces 204 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 206 may be used to enable the server 200 to communicate over a network. The network interface 206 may include, for example, an Ethernet card or adapter (e.g., 10BaseT, Fast Ethernet, Gigabit Ethernet, 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., Random Access Memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., Random Access Memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

The server 200 can be connected to the network elements 122, 124 in the network 100, such as via the network interface 206. This connection provides a conduit through which the hardware in the network 100 can be programmed following instructions from the SDN controller 150, the management system 160, etc.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, processor, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

### Dynamic Inventory Graph Model

The present disclosure includes a dynamic inventory graph model that is stored in a graph database used with the management system 160 and the server 200 for inventory management. For example, the dynamic inventory graph model can be stored in the data store 208.

The following table includes various terms and the corresponding description of such terms, as used herein:

| Term | Description |
|---|---|
| node | The set of points of a graph. This is generally |
| | known as a vertex in graph theory. |
| relationship | A pair of nodes. In the graph database, all |
| | relationships are directed. That is, there |
| | are a start node and end node in the |
| | relationship. This is alsogenerally known |
| | as an edge in graph theory. |
| property | An attribute of a node or relationship. |
| label | A value stored against a node to identify its |
| | kind. A node can have multiple labels in the |
| | graph database. |
| type | A value stored against a relationship to indicate |
| | its kind. A relationship can only have one type |
| | in the graph database. |
| perspective | Dynamic Inventory Graph terminology for the |
| | concept of a partition of the data, such as |
| | the planned perspective, the operational |
| | perspective, the metadata perspective. |
| inventory | This refers to the data in the graph that is |
| instances, | for the typical network inventory model (and |
| inventory nodes, | not the data for plans, activities, metadata, |
| inventory | and so on). |
| relationships | |
| parent and child | Whenever using the terminology of parent and |
| | child, it is with reference to the direction |
| | of the relationship in the graph database, |
| | namely (parent)-[r]->(child). For |
| | example, a: SlotPosition is the parent of the: |
| | Card it is related to. |

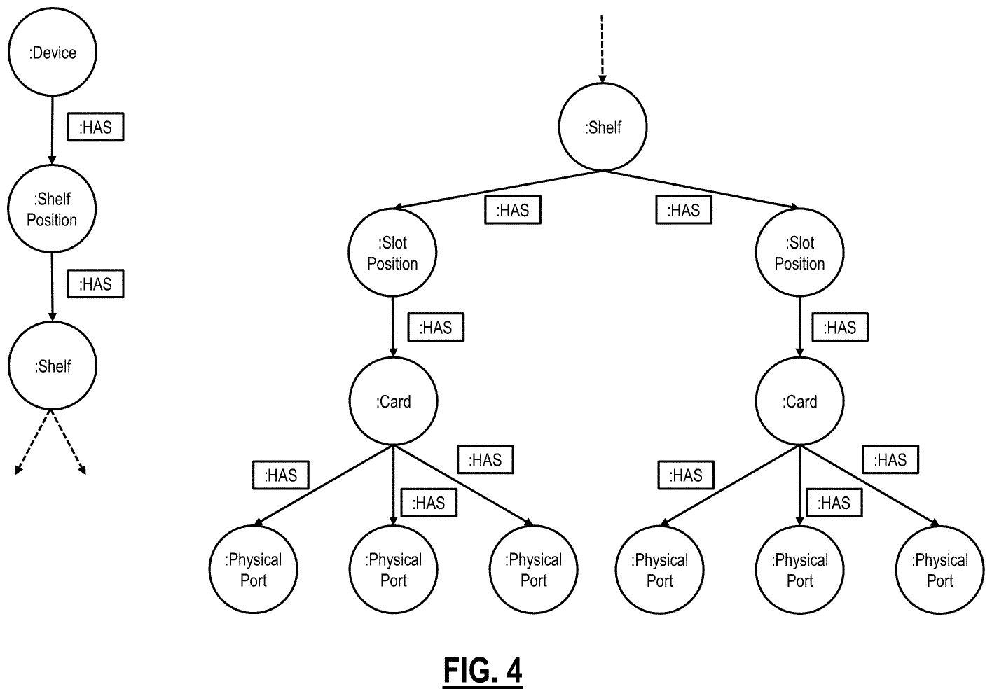

FIG. 3 is a diagram that logically illustrates entries 300 in the graph database. The graph database is used to store data for the management system 160 in a graph format that includes nodes 302 and relationships 304. The nodes 302 can have labels and properties. The relationships 304 can have a type and properties. There is no defined schema of nodes 302 and the relationships 304. The properties can be added when required, and properties that are null are not present. Indexes can be on labels and properties. FIG. 4 is an example of instance data in the graph database. Here, data is modeled for the switch 122 or the network element 124 and associated equipment, i.e., device: shelf position: shelf: slot position:card:physical port.

The purpose of the graph database is to store and record inventory (physical, logical, service, other) and their relationships for inventory use cases. Example inventory use cases include capacity management, planning of inventory changes for physical and logical resources, routing, service impact analysis, federation and reconciliation from external sources, partitioning of data for security, and the like.

The dynamic inventory graph model takes advantage of the flexibility of the graph database. Inventory is created by copying from archetype instances or templates. Relationships are then added between copied nodes where compatible. In general, the model fully expresses the allowed possibilities. Data is not deleted but can be marked as destroyed.

### Metadata Specification in the Graph Database

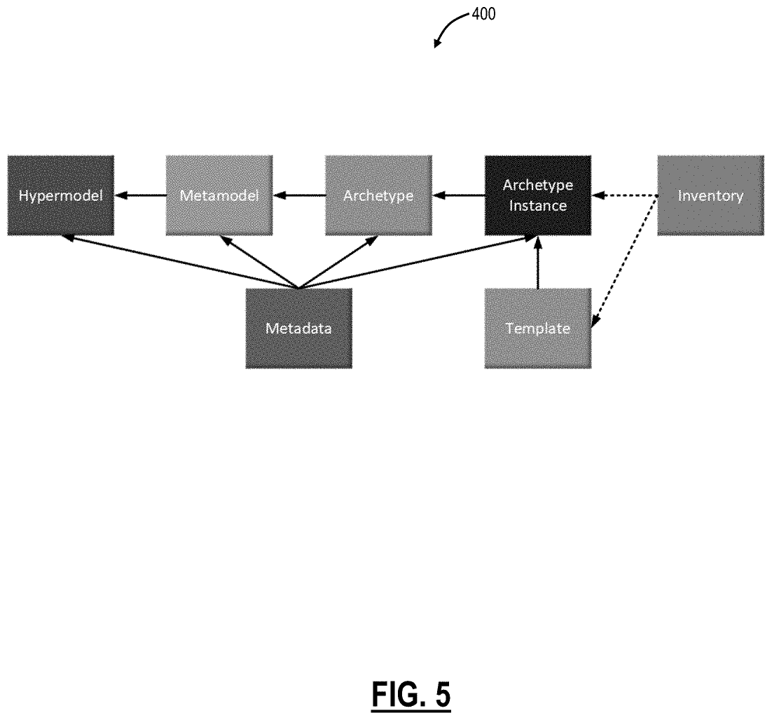

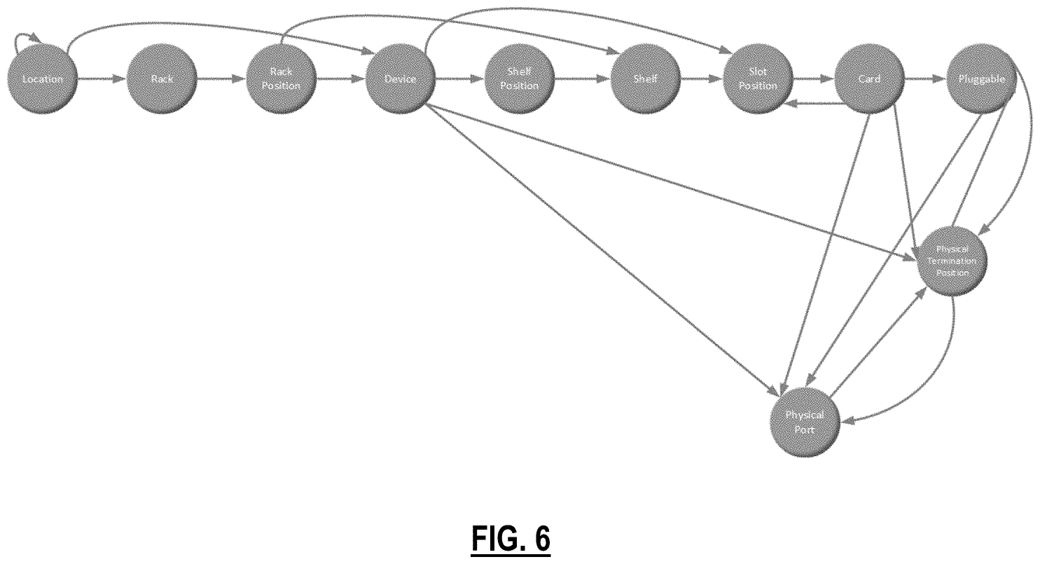

FIG. 5 is a diagram of a dynamic inventory graph 400. The dynamic inventory graph 400 is a graph representation of the classes of inventory nodes and their possible relationships prior to further refinement into types (Archetypes) and their compatibility, and enforcement of any further constraints from metadata or business rules. The dynamic inventory graph 400 has layers of granularity to provide management of underlying networking components with a model for what is possible in relating metamodel nodes that can be used when constructing archetypes.

The following table defines the components in the dynamic inventory graph 400.

| Component | Description |
|---|---|
| Hypermodel | Defines the highest level of an entity and |
| | the relationships between them, such as |
| | Equipment, Address, and Interface. |
| Metamodel | This refines the Hypermodel to define |
| | inventory objects such as Device, Card, |
| | Location, Physical Port |
| Archetype | Archetypes are used to specify the types |
| | and compatibility of kinds of Metamodel. |
| | For example, each device type will have |
| | its own Archetype. |
| Metadata | Metadata allows the specification of |
| | behavior and rules such as planning |
| | transition logic, business rules and |
| | sets of properties for relationships and |
| | nodes. Metadata can be assigned to the |
| | Hypermodel, Metamodel and Archetype model |
| | depending on the level of granularity of |
| | the rule. |
| Archetype | Archetype instances are used to define |
| Instance | the composition of archetypes that can |
| | then be copied into inventory instances. |
| Template | A combination of multiple archetype instances |
| | to create larger structures for copying into |
| | instances, such as devices already fully |
| | populated with cards, or locations already |
| | populated with equipment for site rollout. |
| Inventory, | This refers to the data in the graph that is |
| Inventory | for the typical network inventory model (and not |
| Instances, | the data for plans, activities, metadata, and |
| Inventory | so on). For reasons of locking and performance, |
| Relationships | currently there are no explicit relationships |
| | created between Inventory and other components. |
| | Instead a property is used to point back to its |
| | archetype instance. |

Archetypes and Archetype Instances refine the Metamodel further to provide the full picture of the metadata for Inventory instances. Archetypes describe the types of Inventory instances and allowed compatibilities between them. Archetype Instances describe the composition of the Inventory instances. Relationships between groups of Archetype Instances enables modeling complex combinations of exclusivity of composition from elements of the groups.

The Metamodel defines the typical models necessary for an inventory solution. The following describes a Metamodel to Hypermodel graph.

| :Metamodel node name | :Hypermodel node name |
|---|---|
| Location | Address |
| RackPosition | Address |
| ShelfPosition | Address |
| SlotPosition | Address |
| PhysicalTerminationPosition | Address |
| LogicalPosition | Address |
| Rack | Equipment |
| Device | Equipment |
| Shelf | Equipment |
| Card | Equipment |
| Pluggable | Equipment |
| PhysicalPort | Interface |
| LogicalInterface | Interface |
| LogicalConnection | Connection |
| LogicalCrossConnection | Connection |
| PhysicalConnection | Connection |
| InternalConnection | Connection |
| Network | Connection |
| Service | Abstraction |
| Order | Abstraction |
| Customer | Abstraction |
| Plan | Plan |
| Activity | Activity |

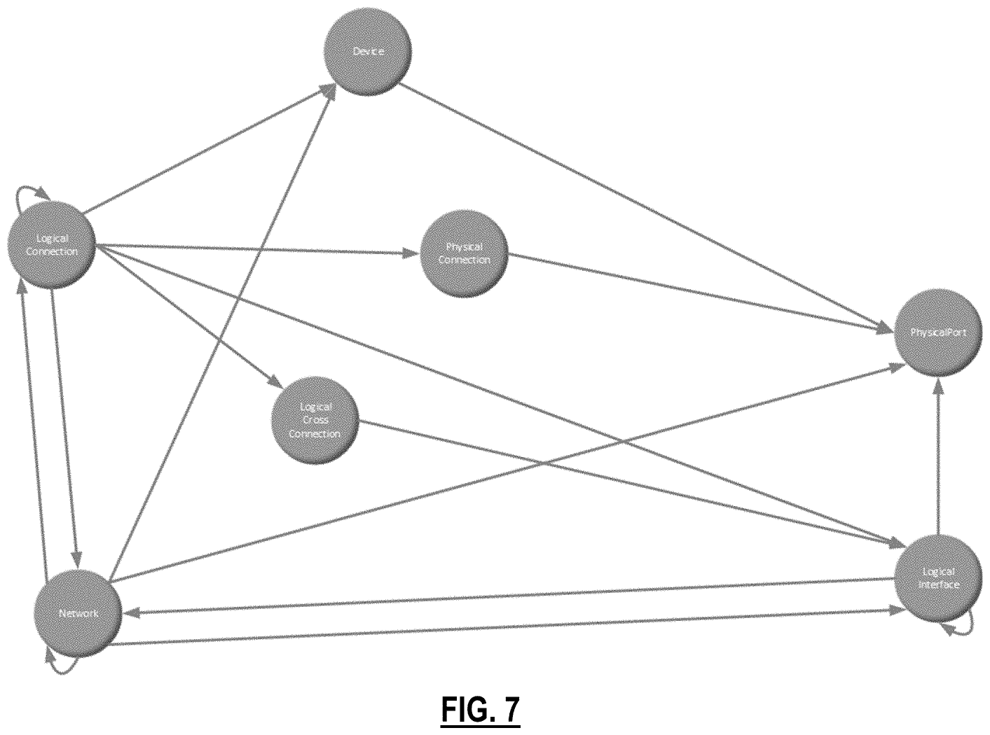

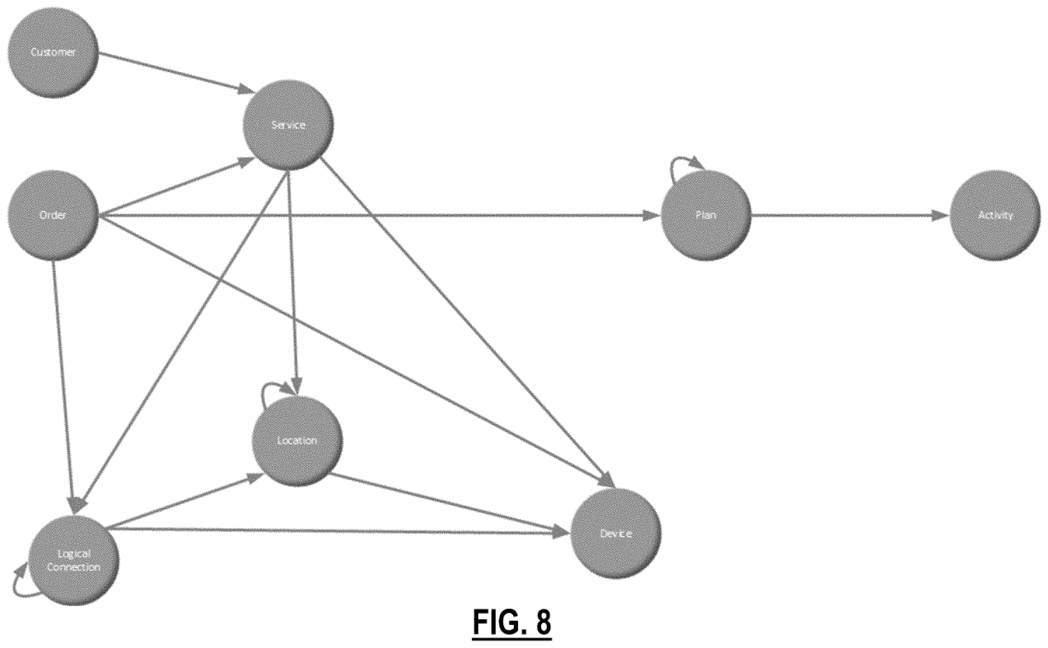

FIG. 6 is a graph of a Metamodel excerpt for equipment in the graph format. Here, the Metamodel defines physical equipment. FIG. 7 is a graph of a Metamodel excerpt for logical connectivity. Here, logical and physical connections in a network are defined. FIG. 8 is a graph of a Metamodel excerpt for aspects of customer ordering, servicing, and planning.

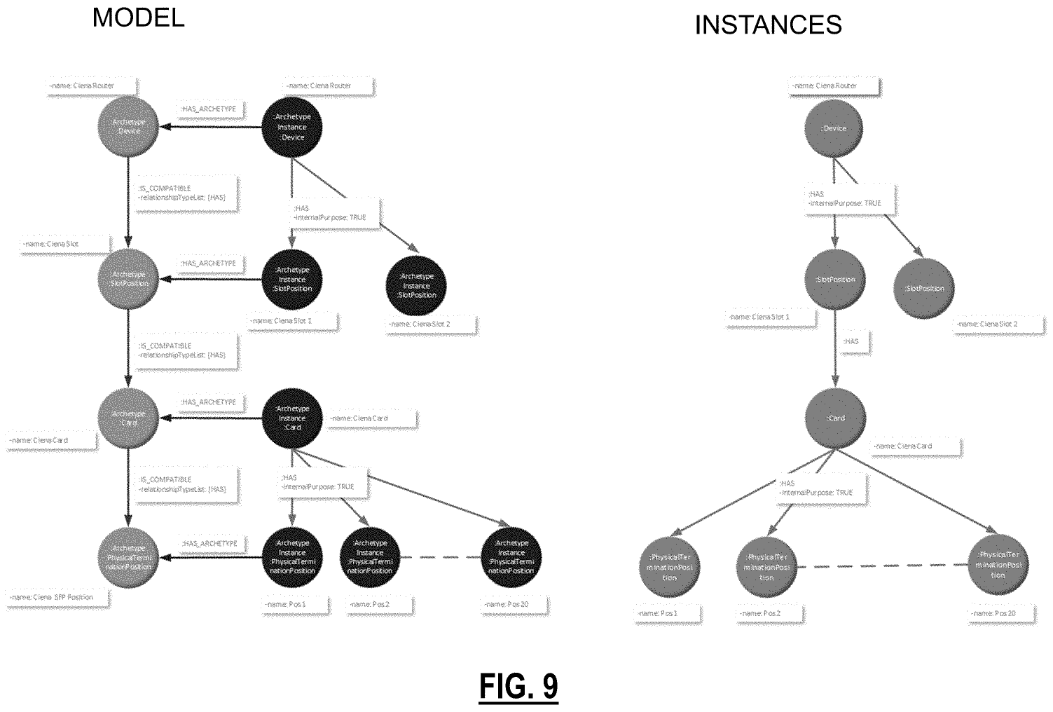

Archetypes define the ‘Types’ for a Metamodel node. For example, a specific type of network element, a specific module in the network element, a data port in the network element (e.g., Ethernet interface), a switch in the network element (e.g., Optical Channel Connection), etc. The allowed Compatibility of relationships between inventory is defined by the Archetypes. Archetype Instances are pre-built combinations of Archetypes. Instances are created by copying Archetype Instances and relating them together within allowed compatibilities. Templates provide larger pre-built combinations of instances, which can also be copied to generate instances. FIG. 9 is a graph of Archetypes and Archetype Instances.

The Archetypes and Archetype Instances provide an interface-based model approach used for capacity and channelization. This model is closer to the network representation than a purely connection based model. Interfaces can be created independently of connections. The compatibly between interface hierarchies and channelized structures can be modeled.

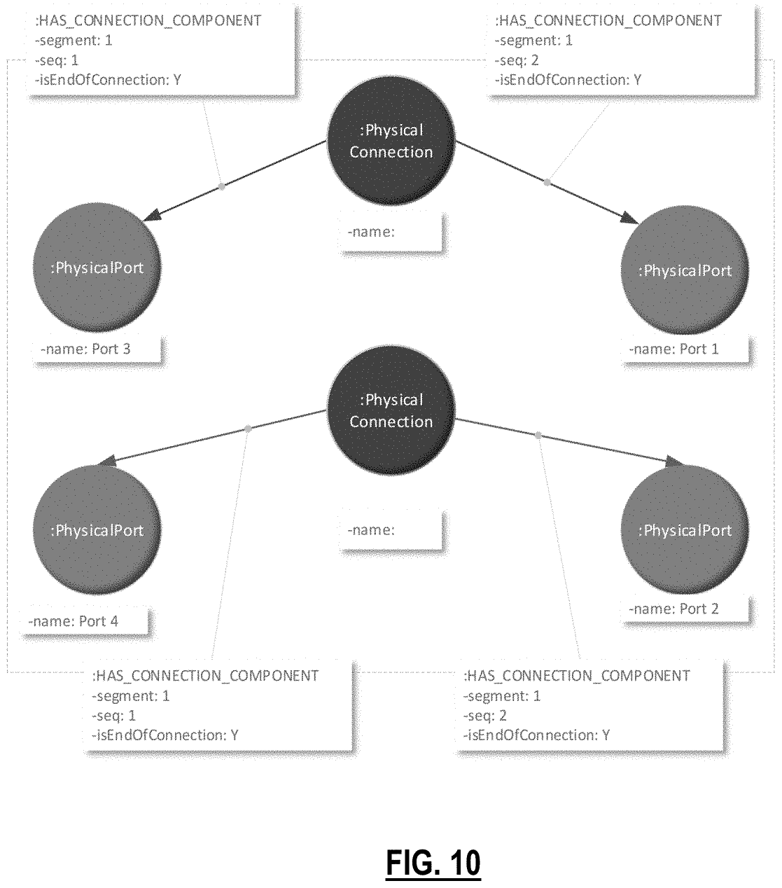

A Connection is a set of route elements, including Physical Ports, Physical Connections and Cross Connections, Logical Interfaces, and Logical Connections and Cross Connections. The model supports sequential and parallel routing; protection mechanisms; point-to-point, point-to-multipoint, multipoint-to-multipoint scenarios, Virtual Private Networks (VPNs). FIG. 10 is a graph of an example physical connection. The graph can be expanded to show other connections as well, including an Optical Transport Network (OTN) set of connections, Ethernet over OTN, etc.

### Perspectives

As described herein, perspectives are used to identify whether nodes and relationships should be visible in a particular view of the graph database. An example use case for this is to indicate whether inventory data is planned or operational. It is also used for marking whether data is viewable as metadata. Properties (referred to as markers) on relationships are used to record whether the relationship between two nodes has been created or destroyed in a particular perspective. The nodes are considered visible in the perspective if the relationship is.

Perspectives are used to identify whether nodes and relationships should be visible in a particular view of the database. A use case is to indicate whether inventory data is planned or operational. It is also used for marking whether data is viewable as metadata. Relationships are used to record whether data is created or destroyed in a particular perspective using properties referred to as markers. A node is considered visible in a perspective, roughly speaking, if it has a relationship with a create but not a destroy in that perspective. Shortcut properties are also recorded on the nodes (and relationships) to indicate if a node is part of the latest view for a given perspective. This helps for example in querying in the planning solution. The shortcut properties can be used to “force” an instance to be visible in a perspective even if its relationships (or lack of them) would indicate otherwise.

In an embodiment, planned data (not yet deployed, provisioned, installed, etc.) and operational data (currently operating in the network) is recorded using separate perspectives. Perspectives are used for visualization of the inventory data, and a user can view the operational data and the planned data, based on the perspectives.

A user can make planned changes against the inventory using Activities in a Plan Perspective. Dates can be specified when the change is anticipated to operationally start or end. Dependencies are created between activities using rules to ensure resources are available from one activity for another when required. Resource constraints are implemented as Rules, such as not allowing two operational cards in the same slot. A separate activity is used to transition the changes of one or more planned activities to become Operational.

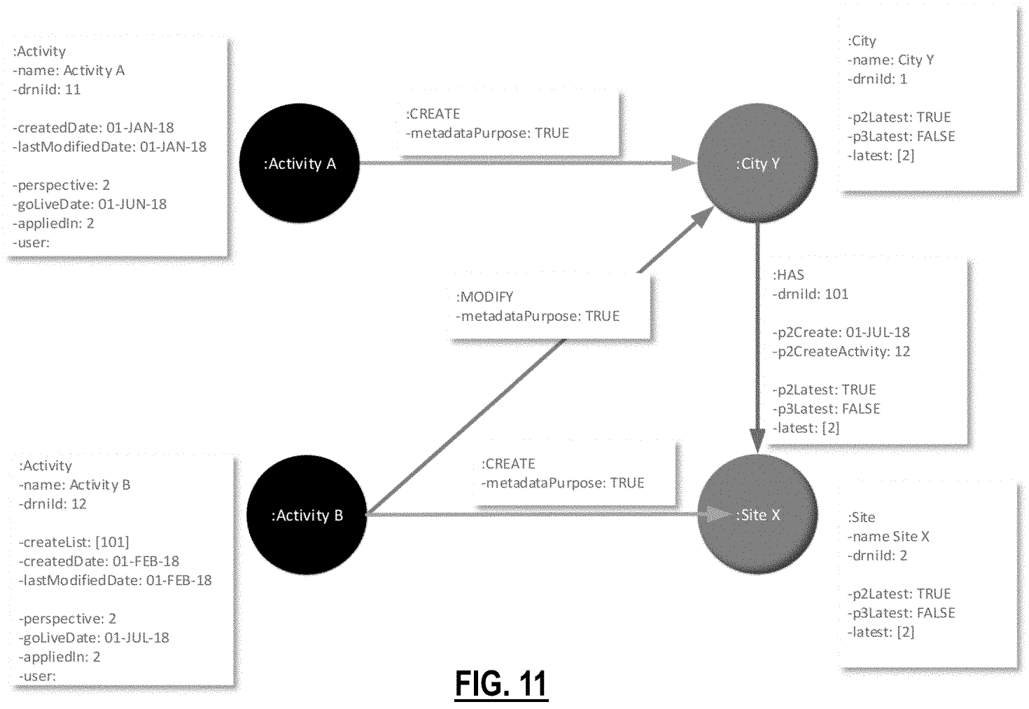

FIG. 11 is a graph illustrating an example of Perspectives and Activities. Inventory changes take place in a Perspective and are actioned by an Activity. An activity is the smallest unit of (business) change. Relationships between nodes determine what is visible in a given perspective. Example Perspectives can include Plan, Operational, and Metadata. An Application Programming Interface (API) can maintain various Properties ‘shortcuts’ to the Actions against Nodes and Relationships.

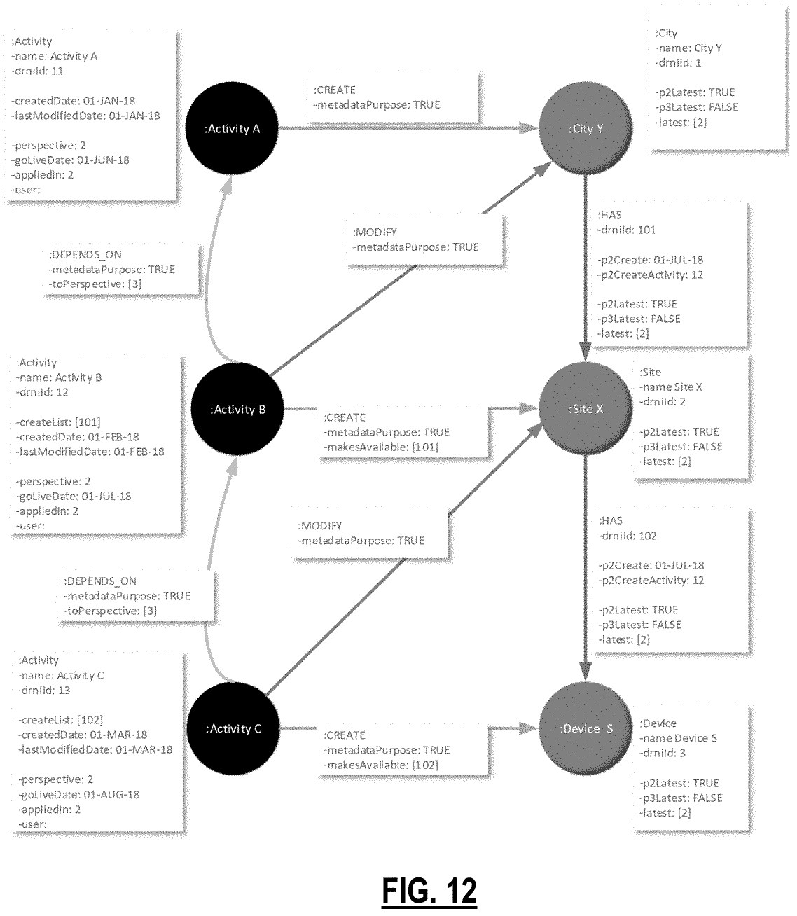

FIG. 12 is a graph illustrating an example of Dependency Management in a graph. Changes can be planned with a target ‘Go-Live’ Date to ensure that changes take place in the right order. The planned dates and the nature of the Relationships are used to create dependencies between activities. When a planned change is transitioned to be operational, the dependencies are taken into account.

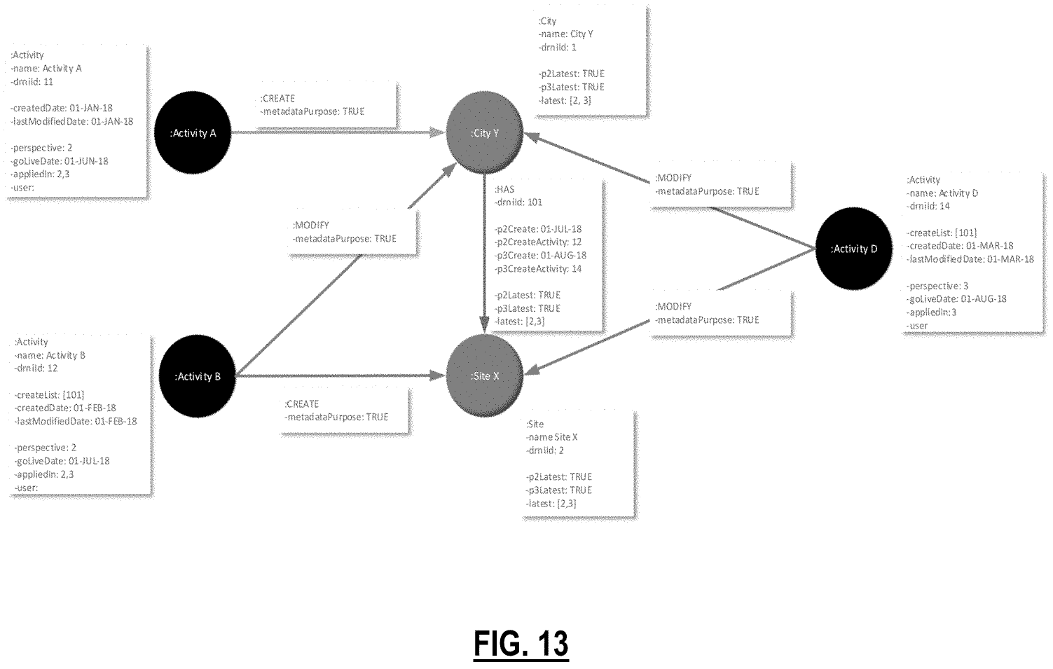

FIG. 13 is a graph illustrating a transition from planning to operational. Markers are set for the operational perspective, but no new Relationships between inventory are created.

The calculation of what is visible to show in a read-only operational or planned view can be adjusted to be relative to a point in time (the concept of a timeline slider). Ease of Rollback (and Roll-Forward) by simple manipulation of the planning properties in the model. Plans can be used to group a set of Activities for business purposes, and Orders act on Plans. System-generated, user-friendly History of inventory changes is available in a UI, based on the Activities and associated data.

Perspectives can be used for other partitioning purposes, for example, to separate discovered data from the as-designed Operational and Planned Data; provide security for data access restriction, Users can be given roles to have visibility of a particular perspective; partition different inventories within a single customer implementation; partition demo or test data; property-level security on a user role basis; distinct schemas in different graph repositories; and the like.

For the Perspectives, properties of a relationship are included within the graph database to indicate if the relationship is considered visible in a perspective in a telecom inventory system. The same relationship can be used for multiple perspectives simultaneously.

### Behavior Modeling

The present disclosure models behaviors (business rules for validation of planning, for setting various properties or manipulating other instance data) through data on Metadata nodes that define the code to execute and/or the data to be used by the logic in that code to provide a certain behavior. For example, the Metadata nodes are illustrated in FIG. 5. Metadata nodes are related to the Hypermodel, Metamodel, Archetype, or Archetype Instance nodes to define the behavior of all instances of that node, for example all devices, locations, logical connections, etc. It should be noted these behaviors are not defined directly on the Hypermodel, Metamodel, Archetype or Archetype Instance nodes. The same Metadata node can be related to multiple Hypermodel, Metamodel, Archetype or Archetype Instance nodes to ensure they all have the same behavior.

The behavior of an inventory item is represented by nodes in the graph related to the desired level of the model (Hypermodel, Metamodel, Archetype, or Archetype Instance nodes) where the behavior should apply, rather than directly indicated on the model itself. The separation of behavior from the definition of the models means behavior can be delivered once and associated to entities that should exhibit that behavior whenever required. Furthermore, the use of perspectives on the relationships between the model and the behavior means that inventory items can have different behavior when viewed from different perspectives. For example, a device could be drawn in a diagram in a different way depending on perspective, or free space analysis for capacity consumption can be calculated in different ways depending on perspective.

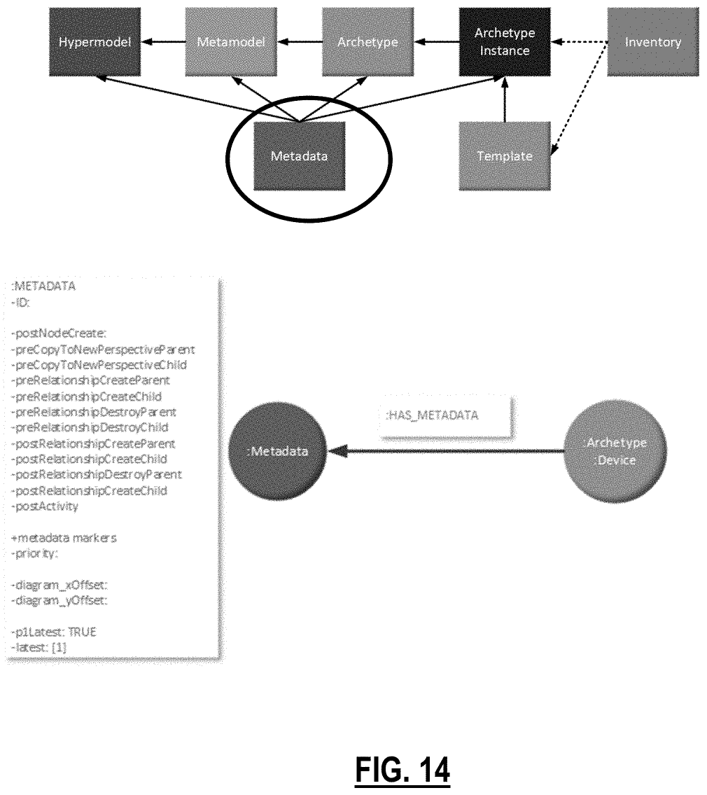

FIG. 14 is a graph example illustrating Metadata nodes. Metadata Nodes are associated with other Nodes in the model to specify the code to execute at the various callout points (pre- and post-events) to implement business and other rules. Example callouts include Naming, Planning rules, State Transition, Complex compatibilities and validations, Capacity calculations, Register a notification, and the like.

### Process for Inventory Management Via a Graph Database

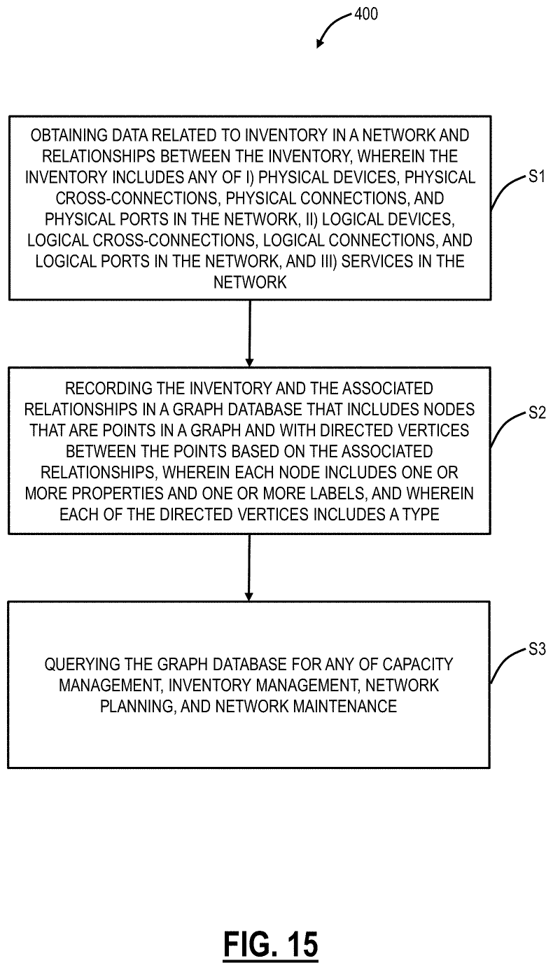

FIG. 15 is a flowchart of a process 400 for inventory management via a graph database. The process 400 can be a computer-implemented method, embodied in a non-transitory computer-readable medium with instructions that, when executed, cause a processor to perform steps and via a server or other processing device.

The process 400 includes obtaining data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network (step S1); recording the inventory and the associated relationships in a graph database that includes nodes that are points in a graph and with directed vertices between the points based on the associated relationships, wherein each node includes one or more properties and one or more labels, and wherein each of the directed vertices includes a type (step S2); and querying the graph database for any of capacity management, inventory management, network planning, and network maintenance (step S3).

The graph database can include a plurality of layers of granularity including metadata that is used to specify behavior and rules between the nodes and the relationships. Again, the graph database can include a plurality of layers of granularity including a Hypermodel that defines the nodes and the relationships, including equipment, addresses, and interfaces and a Metamodel that refines the Hypermodel to define inventory objects including devices, cards, locations, and ports. Further, the graph database can include a plurality of layers of granularity including an Archetype and Archetype Instance, wherein the Archetype defines a type of inventory and compatibilities, and the Archetype Instance defines composition of the inventory.

The process 400 can further include defining a perspective for each node where the perspective is one of planned and operational, wherein the perspective is utilized to determine visibility during the querying. The perspective for the planned nodes can include a date when it transitions to operational. The process 400 can further include presenting a User Interface with a graphical representation based on the querying. The nodes can include any of a location, a rack, a shelf, a slot position on the shelf, a card in the slot position, a pluggable in the card, and one or more physical ports in the card or the pluggable.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable medium comprising instructions that, when executed, cause a processor to perform steps of:
obtaining data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network;
recording the inventory and the associated relationships in a graph database that includes nodes that are points in a graph and with directed vertices between the points based on the associated relationships, wherein each node includes one or more properties and one or more labels, and wherein each of the directed vertices includes a type; and
querying the graph database for any of capacity management, inventory management, network planning, and network maintenance.

2. The non-transitory computer-readable medium of claim 1, wherein the graph database includes a plurality of layers of granularity including metadata that is used to specify behavior and rules between the nodes and the relationships.

3. The non-transitory computer-readable medium of claim 1, wherein the graph database includes a plurality of layers of granularity including a Hypermodel that defines the nodes and the relationships including equipment, addresses, and interfaces and a Metamodel that refines the Hypermodel to define inventory objects including devices, cards, locations, and ports.

4. The non-transitory computer-readable medium of claim 1, wherein the graph database includes a plurality of layers of granularity including an Archetype and Archetype Instance, wherein the Archetype defines a type of inventory and compatibilities, and the Archetype Instance defines composition of the inventory.

5. The non-transitory computer-readable medium of claim 1, wherein the instructions that, when executed, further cause the processor to perform steps of
defining a perspective for each node where the perspective is one of planned and operational, wherein the perspective is utilized to determine visibility during the querying.

6. The non-transitory computer-readable medium of claim 5, wherein the perspective for the planned nodes includes a date when it transitions to operational.

7. The non-transitory computer-readable medium of claim 1, wherein the instructions that, when executed, further cause the processor to perform steps of
presenting a User Interface with a graphical representation based on the querying.

8. The non-transitory computer-readable medium of claim 1, wherein the nodes include any of a location, a rack, a shelf, a slot position on the shelf, a card in the slot position, a pluggable in the card, and one or more physical ports in the card or the pluggable.

9. An apparatus comprising:
a processor; and
memory storing instructions that, when executed, cause the processor to
obtain data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network,
record the inventory and the associated relationships in a graph database that includes nodes that are points in a graph and with directed vertices between the points based on the associated relationships, wherein each node includes one or more properties and one or more labels, and wherein each of the directed vertices includes a type, and
query the graph database for any of capacity management, inventory management, network planning, and network maintenance.

10. The apparatus of claim 9, wherein the graph database includes a plurality of layers of granularity including metadata that is used to specify behavior and rules between the nodes and the relationships.

11. The apparatus of claim 9. wherein the graph database includes a plurality of layers of granularity including a Hypermodel that defines the nodes and the relationships including equipment, addresses, and interfaces and a Metamodel that refines the Hypermodel to define inventory objects including devices, cards, locations, and ports.

12. The apparatus of claim 9, wherein the graph database includes a plurality of layers of granularity including an Archetype and Archetype Instance, wherein the Archetype defines a type of inventory and compatibilities, and the Archetype Instance defines composition of the inventory.

13. The apparatus of claim 9, wherein the instructions that, when executed, further cause the processor to
define a perspective for each node where the perspective is one of planned and operational, wherein the perspective is utilized to determine visibility during the query.

14. The apparatus of claim 13, wherein the perspective for the planned nodes includes a date when it transitions to operational.

15. The apparatus of claim 9, wherein the instructions that, when executed, further cause the processor to
present a User Interface with a graphical representation based on the querying.

16. The apparatus of claim 9, wherein the nodes include any of a location, a rack, a shelf, a slot position on the shelf, a card in the slot position, a pluggable in the card, and one or more physical ports in the card or the pluggable.

17. A method comprising:
obtaining data related to inventory in a network and relationships between the inventory, wherein the inventory includes any of i) physical devices, physical cross-connections, physical connections, and physical ports in the network, ii) logical devices, logical cross-connections, logical connections, and logical ports in the network, and iii) services in the network;
recording the inventory and the associated relationships in a graph database that includes nodes that are points in a graph and with directed vertices between the points based on the associated relationships, wherein each node includes one or more properties and one or more labels, and wherein each of the directed vertices includes a type; and
querying the graph database for any of capacity management, inventory management, network planning, and network maintenance.

18. The method of claim 17, wherein the graph database includes a plurality of layers of granularity including metadata that is used to specify behavior and rules between the nodes and the relationships.

19. The method of claim 18, further comprising
defining a perspective for each node where the perspective is one of planned and operational, wherein the perspective is utilized to determine visibility during the querying.

20. The method of claim 18, further comprising
presenting a User Interface with a graphical representation based on the querying.
